(19) United States
(12) Patent Application Publication
(10) Pub. No.: US 2006/0133394 A1
(43) Pub. Date: Jun. 22, 2006

(54) Methods of wireless backhaul in a multi-tier WLAN

(76) Inventors: Christopher G. Ware, Chicago, IL (US); Randy L. Ekl, Lake Zurich, IL (US); Colin D. Frank, Park Ridge, IL (US); Aparna Pandey, Chicago, IL (US)

Correspondence Address: MOTOROLA, INC., 1303 EAST ALGONQUIN ROAD, IL01/3RD, SCHAUMBURG, IL, 60196, US

(21) Appl. No.: 11/018,974

(22) Filed: Dec. 21, 2004

(51) Int. Cl. H04J 3/22; H04L 12/56; H04L 12/28; H04L 12/403; H04L 12/42; H04J 3/16

(52) U.S. Cl. 370/408; 370/465; 370/449

(57) ABSTRACT

Methods for managing wireless backhaul in a multi-tier wireless local area network are disclosed. The methods comprise maintaining a polling list wherein the polling list specifies the children to be serviced, transmitting a communication in the downstream direction to a child in the polling list, receiving exception communications from the child, and updating the polling list in response to the exception communication.

### FIELD OF THE INVENTION

The present invention relates generally to wireless communication systems and in particular to the field of wireless backhaul in wireless local area networks.

### BACKGROUND OF THE INVENTION

In a wireless local area network (WLAN), wireless backhaul comprises access points (APs) necessary to transport communications from a client served by a coverage access point (CAP) through to an access point (AP) that is directly connected to a fixed network infrastructure, as termed a “wired” AP. In a WLAN, typically the clients are endpoints of a communication path, and the APs are typically stationary and the intermediaries by which a communication path to a client may be established or maintained. To reduce the number of wired APs required to provide coverage for a given area, a layer of intermediate APs is placed between the CAPs and the wired APs. This layer of intermediate APs, the associated CAPs, and the wired APs are all in communication wirelessly and are collectively termed “wireless backhaul.” The communications in the wireless backhaul take place on a communications channel that is a shared radio frequency (RF) frequency where the APs utilizing the communications channel must share the time that they use it.

Each AP, whether intermediate, coverage, or wired, needs to handle communications in two directions. The first direction is from the client through the wireless backhaul to a wired AP and is termed “upstream.” The second direction is from the wired AP through the wireless backhaul to the client and is termed “downstream.” Because the communications channel is shared, each AP needs to effectively manage its access to the communications channel for both the upstream and downstream directions and manage its access in a manner that does not interfere with another AP's access to the communications channel.

Accordingly, there exists a need for an improved method of wireless backhaul in a wireless local area network.

### BRIEF DESCRIPTION OF THE FIGURES

A preferred embodiment of the invention is now described, by way of example only, with reference to the accompanying figures in which:

FIG. 1 is an example block diagram illustrating a typical wireless local area network system in accordance with an embodiment of the invention.

FIG. 2 is a flow diagram illustrating functionality performed by an AP functioning as a parent in accordance with an embodiment of the invention.

FIG. 3 is a flow diagram illustrating functionality performed by an AP functioning as a child in accordance with an embodiment of the invention.

FIG. 4 is a timing diagram illustrating in accordance with an embodiment of the invention.

It will be appreciated that for simplicity and clarity of illustration, elements shown in the figures have not necessarily been drawn to scale. For example, the dimensions of some of the elements are exaggerated relative to each other. Further, where considered appropriate, reference numerals have been repeated among the figures to indicate identical elements.

### DETAILED DESCRIPTION

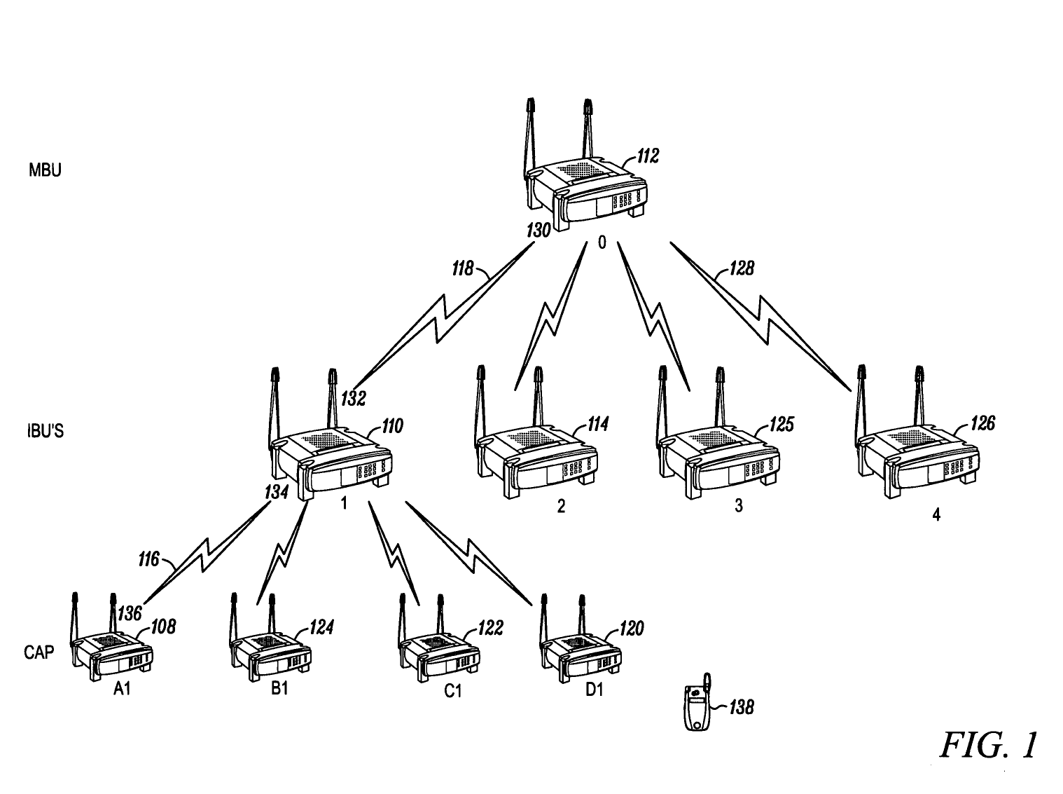

An embodiment of the present invention is described with reference to FIG. 1. Shown in FIG. 1 is a multi-tier wireless local area network (WLAN) 100. The invention may be thought of as a multi-tier WLAN and/or be embodied in a multi-tier WLAN. The WLAN is termed multi-tier to specify that there are multiple tiers of nodes, e.g. multiple tiers of access points (APs) and/or multiple tiers of clients, where a node is a well known term in the art and means a client or an access point. On the AP side of the multi-tier WLAN communications hierarchy, a single AP 112 communicates with APs in a second tier 110, 114, 125, 126. In an exemplary embodiment, the tier 1 AP 112 is termed a master backhaul unit (MBU) and provides communications to a wired network (not shown). As shown in FIG. 1, the second tier APs 110, 114, 125, 126 communicate with coverage APs and are termed intermediate backhaul units (IBUs). Although only two tiers of APs are shown in FIG. 1, many more tiers of APs may exist and are considered to be obvious extensions of FIG. 1. For example, a multi-tier WLAN may comprise tier 1, tier 2, tier 3, and tier 4 APs. In any case, the coverage APs communicate with the clients of the multi-tier WLAN where the clients may also be tiered.

The distinction between coverage APs and tiered APs, e.g. tier 1 AP or tier 2 AP, is that a coverage AP interfaces with the clients of the multi-tier WLAN and the tiered APs are the intermediaries of a communication between the clients in the multi-tier WLAN. In an alternate embodiment, the functionality provided by a tiered AP may be combined into a coverage AP, and vice versa, so one AP, whether tiered or coverage, may provide both functions.

In one embodiment, each AP in the multi-tier WLAN implements the IEEE 802.11 PCF protocol where an AP sends a poll message to a client and the client responds. In an alternative embodiment, each AP in the multi-tier WLAN implements the IEEE 802.11E protocol where the AP implements quality of service enhancements. In another alternative embodiment, a contention based protocol may be used to provide each AP with access to the communications channel. In an illustrative embodiment, each access point has a polling list that comprises information about APs that would like to be serviced. The polling list includes information such as MAC address and a channel number for the communication. Alternatively, the polling list may also include information such as signal strength. The process of populating the polling list is performed by a number of network protocols, such as beacon transmissions (also termed “beacons”), explicit requests by clients, distance vector routing, and other similar protocols, and is beyond the scope of this disclosure.

On the client side of the multi-tier WLAN communications hierarchy, a client 138 communicates directly with a single coverage AP to provide access to the wired network (not shown) or to the rest of the wireless multi-tier WLAN communications hierarchy. Although there is only one client 138 shown in FIG. 1, many more clients and/or tiers of clients may exist. In any case, the clients of the multi-tier WLAN communicate with the coverage APs of the multi-tier WLAN. As used herein, the coverage AP that a client is associated with is termed a serving coverage AP.

As will be appreciated by those of skill in the art, the clients may be any suitable type of wireless communications device capable of communicating within a wireless network, such as computers, personal data assistants (PDAs), fixed mounted devices, vehicular mounted devices, or handheld devices, as well as others. Certain of the clients may also be connected to a fixed communications infrastructure, if desired.

Communications in the multi-tier WLAN occur in one of two directions, namely upstream and downstream. Upstream communications occur between an AP and its neighboring AP which is closer to the MBU in the multi-tier WLAN. For example, an upstream communication occurs when a CAP sends a communication to an IBU. Downstream communications occur between an AP and its neighboring AP which is closer to the client in the multi-tier WLAN. For example, a downstream communication occurs when an IBU sends a communication to a CAP. Further, in one embodiment, both upstream and downstream communications in any single AP use a single RF frequency. For example, AP 1 may use a communications channel having a frequency of 4.9475 GHz for both upstream and downstream communications whereas AP 4 may use a communications channel having a frequency of 4.9725 GHz for both upstream and downstream communications.

An AP functions as a “parent” when it sends communications in a downstream direction and/or receives communications from an upstream direction. In contrast, an AP functions as a child when it sends communications in an upstream direction and/or receives communications from a downstream direction. Because each AP in the wireless backhaul is able to send and receive communications in both the upstream and downstream directions, each AP in the wireless backhaul functions as both as a parent and a child. However, each AP can not indefinitely function as either a parent or a child, so the AP must divide its time between the time that it spends functioning as a parent and the time that it spends functioning as a child. In one embodiment, the time that an AP spends as a parent and the time that the AP spends as a child is predetermined and triggered by a timer. For example, the AP may spend 25 msec as a child and may follow that with 25 msec as a parent.

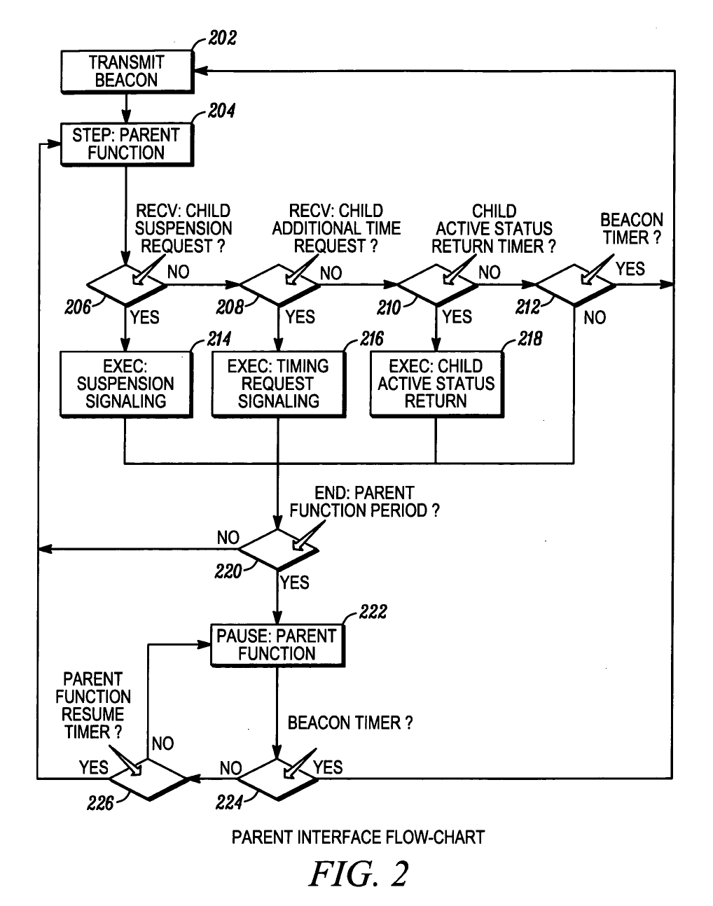

Referring to FIG. 2, shown is a flow chart for the functionality performed by an AP functioning as a parent. The process of functioning as a parent (Block 04) is started when the AP transmits a beacon (Block 202). Functioning as a parent involves responding to requests from children, transmitting downstream communications to children, polling children for upstream communications, suspending children from active service, and updating the polling list (Block 204). Having entered the parent function, the AP is required to manage the status of all children it is currently servicing. The AP may receive exception communications where exception communications include requests for a parent from a child or communications from a child to make certain decisions or respond to local timers (Blocks 206, 208, 210, 212). Exception processing refers to processing exception communications. One such request is if a child requests the AP to be suspended from active service in order to perform a network activity (Block 206), then the AP performs suspension signaling processing (Block 214), involving communication directly with the child. Such a network activity for the child may include allowing the AP to act as a CAP, or allowing the AP to act as a parent device servicing other children in the network, or a forced quiet period to prevent network RF interference, or undertaking a direct communication period with a second client device. A second such request is if a child needs to lengthen the time that it spends communicating with the parent (Block 208), then the AP performs timing request processing (Block 216) during which additional time the parent will provide service for the child is negotiated. Such a timer event occurs when the AP needs to return a child to the active service list (Block 210), then the AP returns the child to active service, and updates the polling list accordingly (Block 218). The child will subsequently be serviced by the parent and will receive poll messages, allowing the child to send upstream communications. The parent will also re-commence sending downstream communications to the child. Such behavior constitutes actively servicing the child, and is the primary function of the parent (Block 204). A second such timer event occurs when a timer expires that informs the AP that it is time to end behaving as a parent (Block 212). A third such timer event occurs when a timer expires that informs the parent when it is time to transmit a new beacon message (Block 212). In this case, the parent will transmit the new beacon message (Block 202). If any of these decisions or requests (Blocks 206, 208, 210) are triggered, then the AP performs the processing relating to the decision (e.g. Blocks 214, 216, 218) and checks to see if the time to stop behaving as a parent (Block 220) has begun. If it is, then the parent function is paused (Block 222); otherwise, the AP returns to behaving as a parent (Block 204), and actively servicing children by transmitting downstream communications to active children, and transmitting poll messages to active children allowing each child to transmit upstream communications. In any case, a timer is checked to see if it is time to send a new beacon (Block 224). If the timer has expired, then the AP transmits a new beacon (202) and resumes parent activity; otherwise, the parent function remains paused (Blocks 226, 222). While paused, (Block 222) the parent will also monitor a further timer to determine when the parent is required to resume activity without having to transmit a beacon message (Block 236).

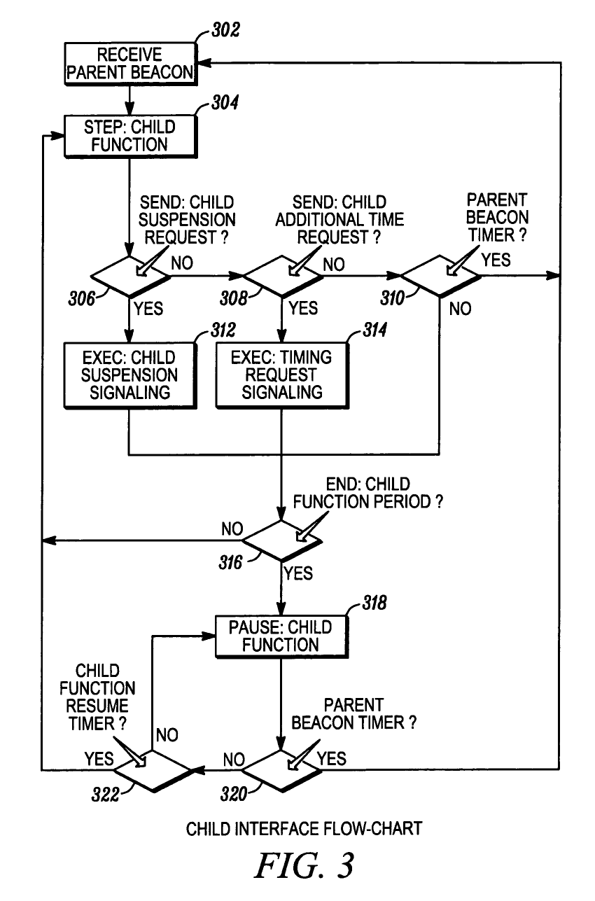

Referring to FIG. 3, shown is a flow chart for the functionality performed by an AP functioning as a child. The process of functioning as a child (Block 304) is triggered by receiving a beacon sent by a parent (Block 302). The process of functioning as a child involves transmitting upstream communications to the parent, receiving downstream communications from the parent, requesting additional service time with the parent, requesting suspension from the polling list for a suspended duration, and setting the time spent as a child (Block 304). Having entered the child function, the AP may have to return to behaving as a parent when exception processing needs to take place. Exception processing refers to processing of certain decisions (Block 306), signaling with the parent of certain decisions (Block 308), or responding to certain internal timer events (Block 310). One such decision is if a network scheduler requests the AP to perform a network activity (Block 306), then the AP performs suspension signaling processing (Block 312). A second such decision is if the AP needs to lengthen the time that it spends as a child (Block 308), then the AP performs timing request processing (Block 314). A third such decision occurs when a timer expires that informs the AP that it is time to receive a beacon message from the parent device (Block 310). If none of these decisions or timers are triggered, (Block 306, 308, 310), then the AP checks a timer to determine if the AP is still required to act as a child (Block 316) If this timer is triggered, the AP ends behaving as a child and pauses the child function (Block 318). While paused (Block 318), the AP will monitor certain timers (Block 320, 322) to determine when future child action is required. One such timer (Block 320) indicates the time at which the AP is required to be executing the child function in order to receive a beacon message from the parent. When this timer expires, the AP receives a beacon message (Block 302) from the parent AP and resumes the child function (Block 304). A second such timer (Block 322) indicates when the AP is required to resume the child function without receiving a beacon message from the parent. When this timer expires, the AP resumes the child function directly (Block 304) without receiving a beacon message from the parent.

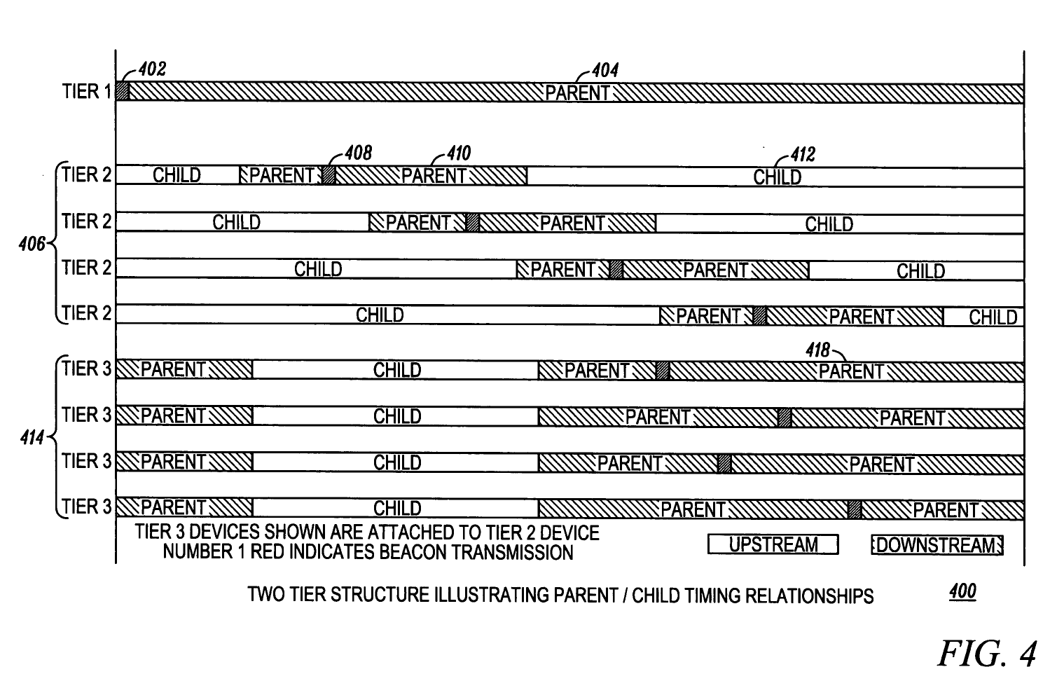

Having described the functionality performed by an AP behaving as a parent and as a child, shown in FIG. 4 is an example timing diagram illustrating the relationships between the APs of FIG. 1. The duration each AP operates as both a parent function and as a child function is illustrated. The tier 1 AP (400) executes a parent function throughout the entire duration shown (404), including transmitting a beacon message (402). Each of the tier 2 APs, (406) split their time between parent and child functions. The tier 2 AP (406) executes a child function (412) with the exception of the duration selected to execute a parent function (410) including transmitting a beacon message (408) to active tier 3 APs (414). Each of the tier 3 APs (414) in turn executes a child function (420) at the same time as the tier 2 APs (406) parent function (410). The tier 3 APs (414) are then able to execute a parent function during the remainder of the time available to them (418).

In general, beacons are defined as packets transmitted by an AP which has information about the multi-tier WLAN such as timing synchronization, traffic queues, and the capabilities of the sender, e.g. the AP. In such an embodiment and as known in the IEEE 802.11 art, beacons transmitted by an AP are transmitted once every beacon interval where a beacon interval is defined as the time between consecutive beacons transmitted by a tier 1 AP, e.g. 300, 301 as shown in FIG. 3. Beacons transmitted by a single AP have a fixed frequency but may or may not be the same frequency with which beacons are transmitted by a different AP. For example, in FIG. 1, tier 1 AP 112 transmits beacons at one rate and tier 2 AP 110 may transmit beacons at a different rate. Further, beacons transmitted by tier 2 AP 114 may be transmitted at yet a different rate.

As mentioned above, an AP behaving as a child may request suspension from service from its parent by sending a communication to its parent. In one embodiment, the communication is a standard IEEE 802.11 packet comprising an information element. In such an embodiment, the information element may have fields such as a) an identification of the child, e.g. a MAC address, b) an action to be performed, e.g. place the child on the polling list, remove the child from the polling list, and request additional service time, and c) the duration of the action. Likewise, a parent may respond to requests for service by sending a communication to a child. In one embodiment, the communication is a standard IEEE 802.11 packet comprising an information element. In such an embodiment, the information element may have fields such as a) an identification of the parent, e.g. a MAC address, b) an action to be performed, e.g. accept child's request, conditionally accept child's request, and reject child's request, and c) the duration of the action.

While the invention has been described in conjunction with specific embodiments thereof, additional advantages and modifications will readily occur to those skilled in the art. The invention, in its broader aspects, is therefore not limited to the specific details, representative apparatus, and illustrative examples shown and described. For example, the subscriber unit and/or the base radio may comprise a storage medium having stored thereon a set of instructions which, when loaded into a hardware device (e.g., a microprocessor), causes the hardware device to perform the following functions of the present invention. The present invention can be implemented in at least one of hardware, firmware and/or software. Various alterations, modifications and variations will be apparent to those skilled in the art in light of the foregoing description. Thus, it should be understood that the invention is not limited by the foregoing description, but embraces all such alterations, modifications and variations in accordance with the spirit and scope of the appended claims.

It should be noted that the terms “a” or “an”, as used herein, are defined as one or more than one. The term “plurality”, as used herein, is defined as two or more than two. The term “another”, as used herein, is defmed as at least a second or more. The terms “including” and/or “having”, as used herein, are defined as comprising (i.e., open language).

We claim:

1. A method for managing wireless backhaul in a multi-tier wireless local area network comprising:
in an access point in the multi-tier wireless local area network, wherein the multi-tier wireless local area network comprnses access points functioning as children and as parents;
wherein a child sends communications in an upstream direction and receives communications from a downstream direction; and
wherein a parent sends communications in a downstream direction and receives communications from an upstream direction;
maintaining a polling list wherein the polling list specifies the children to be serviced;
receiving exception communications from the child; and
updating the polling list in response to an information in the exception communication.

2. The method of claim 1 further comprising the steps of:
transmitting a communication in the downstream direction to a child in the polling list;
receiving a communication in the upstream direction from a child in the polling list.

3. The method of claim 1 wherein the information in the exception communications comprises an action to be performed comprising at least one of a suspension request, additional time request, and active status request.

4. The method of claim 3 further comprising the step of servicing the child at a time specified in the exception communications.

5. The method of claim 4 wherein the step of servicing is exclusive for the child.

6. The method of claim 4 wherein the step of servicing further comprises updating the polling list to specify an active status of the child.

7. The method of claim 1 wherein the step of maintaining adheres to an IEEE 802.11 PCF protocol.

8. A method for managing wireless backhaul in a multi-tier wireless local area network comprising:
at a parent in the multi-tier wireless local area network:
maintaining a polling list of children where the list specifies whether the child requires service from the parent; and
broadcasting a beacon to children specifying a beacon interval for performing the following steps:
(i) choosing a child from the polling list to service for a child duration;
(ii) sending a downstream communication to the child; and
(iii) receiving an upstream communication from a child; and
(iv) performing exception processing to change the child duration; and
(v) updating the polling list in response to exception processing.

9. The method of claim 8 further comprising the step of servicing a next child in the polling list at the expiration of the child duration.

10. The method of claim 8 further comprising the step of functioning as a parent at the expiration of the child duration.

11. The method of claim 8 wherein service further comprises:
performing the following steps during a child duration of the beacon interval:
(i) polling the child for an upstream communication;
(ii) transmitting downstream communications to the child;
(iii) receiving upstream communications from the child; and
(iv) responding to exception communications from the child.

12. The method of claim 11 wherein the exception communications comprises an action to be performed comprising at least one of a suspension request, additional time request, and active status request.

13. The method of claim 12 wherein the exception communications identify the parent's MAC address, the action to be performed, and a duration of the action.

14. A method for managing wireless backhaul in a multi-tier wireless local area network comprising:
at a child in the multi-tier wireless local area network:
receiving a beacon from a parent specifying a beacon interval; and
performing the following steps during a child duration of the beacon interval:
(i) receiving a downstream communication from the parent; and
(ii) sending an upstream communication to the parent; and
(iii) sending exception communications to the parent.

15. The method of claim 14 wherein the exception communications comprises one of a suspension request and additional time request.

16. The method of claim 14 further comprising the step of functioning as a parent at the expiration of the child duration.
